(19) United States
(12) Patent Application Publication
(10) Pub. No.: US 2023/0005507 A1
(43) Pub. Date: Jan. 5, 2023

(54) SYSTEM AND METHOD OF GENERATING MEDIA CONTENT FROM LIVESTREAMING MEDIA CONTENT

(71) Applicant: Logitech Europe S.A., Lausanne (CH)

(72) Inventors: Andrew John CREETH, San Mateo, CA (US); Sean Elliot KAISER, Vancouver (CA)

(21) Appl. No.: 17/856,881

(22) Filed: Jul. 1, 2022

Related U.S. Application Data
(60) Provisional application No. 63/218,296, filed on Jul. 3, 2021.

(51) Int. Cl. G11B 27/031; H04N 21/2187; G06F 3/0489

(52) U.S. Cl. CPC G11B 27/031; H04N 21/2187; G06F 3/0489

(57) ABSTRACT

The embodiments described herein provide streamlined video editing functionalities that can be integrated into the broadcast software, providing a streamer the ability to select video clips to be sent to viewers and saved during a livestreaming session, edit the saved clips after the livestreaming session to generate short-form video content, including necessary information, such as real-time alerts of viewers that appeared during the livestreaming session.

### CROSS-REFERENCE TO RELATED APPLICATIONS

This application claims benefit of U.S. provisional patent application Ser. No. 63/218,296, filed Jul. 3, 2021, which is herein incorporated by reference.

### BACKGROUND

### Field

Embodiments of the present disclosure generally relate to local broadcast software and, more particularly, to integrated and automated editing functionalities within the local broadcast software.

### Description of the Related Art

The established industries of online video streaming, such as YouTube®, Vimeo®, and Facebook®, and internet-based multiplayer gaming combined have led to a new industry of livestreaming, such as Twitch®, YouTube Gaming®, and Facebook Gaming®. The online video streaming primarily serves pre-recorded short-form video, such as several minutes long, while the livestreaming often broadcasts live video, such as a user's gaming experience, often over an hour. During a livestreaming session, broadcast software provides a user (also referred to as a “streamer”) with various functionalities, such as the use of overlays, which are graphical elements to be added to the live video. Once such a livestreaming session is completed, the broadcasted content is either discarded or edited to create a short-form video containing highlights from the broadcasted content that a user may wish to upload to an online video streaming platform.

Conventionally, this post-livestreaming video editing requires saving a broadcasted content within local memory, such as a hard drive of a personal computer, painstakingly cutting clips from the broadcasted content, adding selected saved clips in a sequential order to form a timeline, manually adding transitions between clips, or the like, within a video editing software. Furthermore, a broadcasted content saved on a local memory may not include real-time alerts that appear, for example, when a viewer subscribes, follows, or donates to the streamer during a livestreaming session.

Accordingly, there is a need in the art for streamlined video editing functionalities that can be integrated into the broadcast software, providing a streamer the ability to generate short-form content with the necessary information, such as real-time alerts during a livestreaming session.

### SUMMARY

Described herein is a system and method for capturing viewer interactions, such as real-time alerts, to a live stream of a video file during its streaming, integrating the viewer interactions with the video file, and providing a short-form content video to a video-sharing platform. The short-form content video includes selections of portions of the video file, alterations of the video file, and transitions between selected portions of the video file.

Embodiments described herein provide a method of rendering video files. The method includes sending one or more video files to a plurality of live streaming platforms to make the video files available to a plurality of viewers, receiving streaming events from the plurality of live streaming platforms, where the streaming events include viewer interactions to the video files, rendering a short-form content video by editing, combining the video files, and integrating the streaming events into the short-form content video, and sending the short-form content video to a plurality of video-sharing sites.

Embodiments described herein provide a system for rendering video files, the system comprising: a processor; and a memory coupled to the processor and having loaded therein, for execution by the processor, video editing software. The video editing software being configured to: upload one or more video files to a plurality of live streaming platforms; receive streaming event information that includes viewer interactions to the video files; render a short-form content video by editing, combining the video files, and integrating the streaming event information into the short-form content video; and send the short-form content video to a plurality of video-sharing sites.

Embodiments described herein also provide a non-transitory computer-readable medium comprising instructions that are executable in a processor of a computer system to carry out a method of scheduling a plurality of workloads for execution in a cluster of nodes, the method comprising: uploading one or more video files to a plurality of live streaming platforms; receiving streaming event information that includes viewer interactions to the one or more video files; editing, combining the one or more video files, and integrating the streaming event information to create a preview of a short-form content video; rendering the preview into the short-form content video; and sending the short-form content video to a plurality of video-sharing sites.

Embodiments described herein also provide a method of rendering video files, the method comprising: uploading one or more video files to a plurality of live streaming platforms; receiving streaming event information that includes viewer interactions to the one or more video files; editing, combining the one or more video files, and integrating the streaming event information to create a preview of a short-form content video; rendering the preview into the short-form content video; and sending the short-form content video to a plurality of video-sharing sites.

Further embodiments include a computer-readable medium containing instructions for carrying out one more aspects of the above method and a system configured to carry out one or more aspects of the above method.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1A depicts a first portion of a data streaming environment according to one embodiment.

FIG. 1B depicts a second portion of a data streaming environment according to one embodiment.

FIGS. 2A-2B depict a method of generating media content from livestreaming media content, according to one embodiment.

FIG. 3 depicts a flow of operations for the local broadcast software, the server, and the live streaming platforms, according to one embodiment.

FIG. 4 depicts a flow of operations for the local broadcast software, according to one embodiment.

FIG. 5 depicts a flow of operations for the user editing video, according to one embodiment.

FIG. 6A depicts a flow of operations for the server, according to one embodiment.

FIG. 6B depicts a flow of operations for the multi-stream function of the server, according to one embodiment.

FIG. 6C depicts a flow of operations for the API data collector function of the server, according to one embodiment.

FIG. 7 depicts a flow of operations for a live streaming platform, according to one embodiment.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

The embodiments described herein provide streamlined video editing functionalities that can be integrated into broadcast software, providing a streamer the ability to select video clips to be saved during a livestreaming session, edit the saved clips to generate short-form video content, including necessary information, such as real-time alerts that appeared during the livestreaming session, after the livestreaming session.

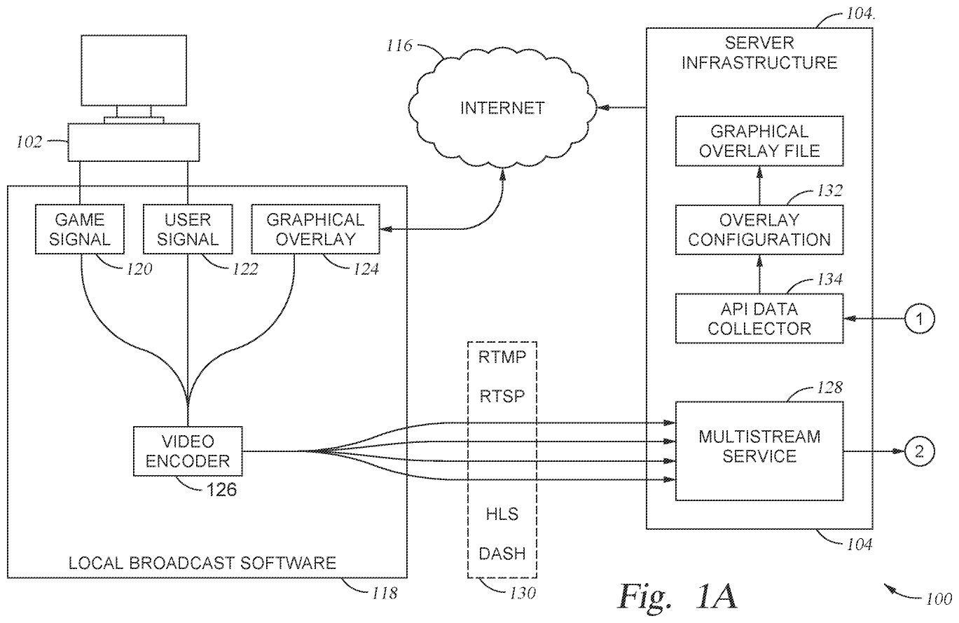

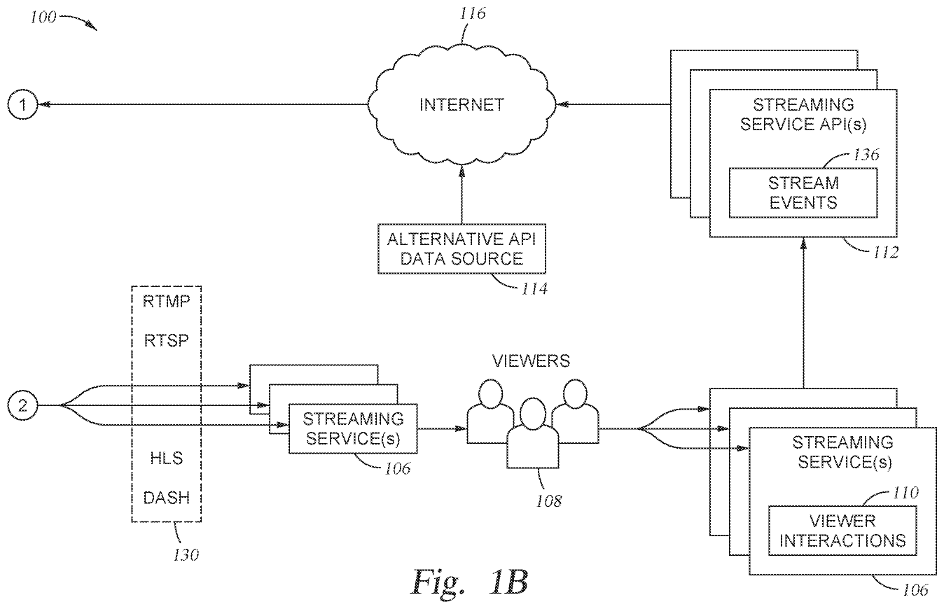

FIGS. 1A and 1B depict a data streaming environment 100 according to one embodiment. The data streaming environment 100 includes a user device 102, a server 104, one or more live-streaming platforms 106, one or more viewers 108, a method for collecting viewer interactions 110, and one or more streaming service application programming interfaces (APIs) 112. The data streaming environment 100 further includes a network 116 that facilitates communication between the user device 102 and the server 104 and between the server 104 and the one or more streaming service APIs 112. In some embodiments, the data streaming environment 100 further includes alternative API data sources 114. The network 116 generally represents any data communications network suitable for transmitting video and audio data (e.g., the Internet) between different locations.

Examples of the user device 102 can include, without limitation, a laptop, a personal computer, a tablet, a smartphone, a virtual or augmented reality computing device, or any related personal computing device. The user device 102 includes a local broadcast software 118 stored in a non-volatile memory of the user device 102. The local broadcast software 118, when executed by a processor of the user device 102, receives a game signal 120 and, optionally, a user signal 122 from the user device 102 and retrieves a graphical overlay 124 from the server 104 via the network 116. The local broadcast software 118 then produces, by a video encoder 126, a video file based on the game signal 120, the optional user signal 122, and the graphical overlay 124. The local broadcast software 118 further sends authentication information to a selected one of the one or more of live-streaming platforms 106 to identify a user uploading the video file and uploads the video file to a multi-stream service 128 using a streaming protocol 130. Additionally, the local broadcast software 118 stores the user settings that are related to the live-streaming platform 106 and used for broadcasting, the encoding settings that are used to produce a video file by the video encoder 126, and the stream settings that are used to upload a video file to the live-streaming platform 106. The one or more live-streaming platforms 106 include, without limitation, Twitch®, YouTube Gaming®, Facebook Gaming®, UStream®, Periscope®, Mixer®, and Smashcast®.

The game signal 120 includes, but is not limited to, an audio/video signal from a video game, a specific application unrelated to a video game, or the user's operating system environment, including some or all applications the user has executed. Multiple game signals 120 and user signals 122 may also be combined to create the game signal 120 or user signal 122.

### Local Broadcast Software

Functions of the local broadcast software 118 include but are not limited to: (1) receiving a game signal 120 and, optionally, a user signal 122 from the user device 102; (2) using the network 116 to retrieve the graphical overlay 124 from the server 104; (3) using the video encoder 126 to produce a video file from the game signal 120, the optional user signal 122, and the graphical overlay 124; (4) storing the video file for a set interval; (5) sending authentication information to the live-streaming platform 106 to identify the user uploading the video file; (6) uploading the video file to a multi-stream service 128 of the server using a streaming protocol 130; (7) storing user settings related to, but not limited to: (7a) the live-streaming platform 106 to which the user may broadcast their encoded video file; (7b) encoding settings used to configure and optimize the video encoder 126; and (7c) streaming settings used to configure and optimize the streaming protocol 130 used to upload the video file to the live-streaming platform 106; and (8) integrated video editing.

### Integrated Video Editing

In the embodiments described herein, the local broadcast software 118 further includes integrated video editing functionalities that generate a short-form content video of a livestreaming content and upload it to an online video streaming platform, such asYouTube®, Vimeo®, Facebook®, and Dailymotion®. Alternatively or additionally, a generated short-form content video can be saved in a local memory device, such as the memory of the user device 102. The video editing functionalities are integrated within the local broadcast software 118 and thus can be performed without separate video editing software.

The integrated video editing functions of the local broadcast software 118 include but are not limited to: (1) setup a combination of keys (referred to as a “hotkey”) by a user; (2) during a livestreaming, when a hotkey is pressed, save the following data, which is not limited to: (2a) a video file having a length of the set interval stored by the local broadcast software 118 at the time when the hotkey is pressed; (2b) the user settings stored by the local broadcast software 118; (2c) information relating to alternative data sources 114 via the graphics overlay file; and (2d) metadata about the data received from the streaming service APIs 112 and the alternative API data sources 114 via the graphics overlay file; (3) after the livestreaming, display all of the video files saved during the livestreaming and any relevant data relating to the video files; (4) allow a user video editing options, but not limited to: (4a) review individual video files; (4b) edit (e.g., trim down) one or more of the video files; (4c) drag individual video files on the display and rearrange the order of the video files; (4d) choose a type and/or duration of transition between adjacent video files; (4e) select video files to be included in a short-form content video to be generated; and (4f) optionally, add audio to the short-form content video to be generated; (5) generate a preview of a short-form content video to be generated; (6) render (e.g., compiling and generating) the previewed short-form content video; (7) publish the generated short-form content video to a video-sharing platform, such as YouTube®, Vimeo®, Facebook®, Dailymotion®; and (8) export the generated short-form content video to a local memory device of the user device.

### Server Elements

The server 104 includes a method for persistent storage, such as a non-volatile memory, and a method for initiating and responding to internet requests, such as a web server. The server 104 stores and makes various user settings available for retrieval, including the user's overlay configuration 132 and the user's graphical overlay 124. The alternative API data sources 114 are data sources unrelated to the one or more streaming service APIs 112 used to create the graphical overlay 124. The server 104 also includes an API data collector 134, which is responsible for aggregating data from one or more streaming service APIs 112 and alternative API data sources 114. Data gathered by the API data collector 134 is then used in combination with the user's overlay configuration 132 to populate the graphical overlay 124. The server 104 further includes the multi-stream service 128, which stores and maintains the user's connections to the live-streaming platform 106. The one or more streaming service APIs 112 and the alternative API data sources 114 connection(s) may be unidirectional or bilateral. The one or more streaming service APIs 112 and the alternative API data sources 114 may also be a RESTful service, a persistent WebSockets connection, or any other method of regularly publishing and sharing information between disparate internet systems. In the embodiment depicted, the server 104 responds to requests from the local broadcast software 118 executing on the user device 102 and retrieves the overlay configuration 132 as needed.

Functions of the server 104 include, but are not limited to: (1) responding to requests from the local broadcast software 118, the user device 102, or the streaming service API 112; (2) hosting a web page that allows users to edit their overlay configuration 132; (3) providing an API data collector 134, which may perform, but is not limited to, the following actions: (3a) maintaining persistent connections with the streaming service API(s) 112; (3b) receiving data from the alternative API data sources 114; (3c) storing metadata about the data received from the streaming service APIs 112 and the alternative API data sources 114; (3d) storing data aggregated from one or more sources related to the user in the user's account; (4) generating the graphical overlay 124 based on the user's overlay configuration 132 at set intervals, based on specific data events as they are received in real time by the API data collector 134, upon request, or otherwise as needed; (5) maintaining user account information; (6) hosting the multi-stream service 128; and (7) hosting and websites required to support the disclosed system.

### Multi-Stream Service

Functions of the multi-stream service 128 in the server 104 include but are not limited to: (1) storing user configuration settings to control which of the one or more livestreaming platforms 106 to which an uploaded video file should be redistributed; (2) optionally receiving authentication information from the local broadcast software 118; (3) if authentication information is received, forwarding said authentication information to the one or more live-streaming platforms 106; (4) receiving the uploaded video file from the local broadcast software 118 via a streaming protocol 130; (5) optionally decoding the video file, then re-encoding the file to optimize it for individual streaming platform(s) 106; or (6) uploading the video file to one or more live-streaming platforms 106 using a streaming protocol 130.

### Livestreaming Functions

Functions of each of the one or more live-streaming platforms 106 include but are not limited to: (1) storing account details for the user; (2) receiving authentication information from the local broadcast software 118 and/or the multi-stream service 128; (3) using the authentication information to identify the user uploading the video file; (4) receiving the uploaded video file from the multi-stream service 128 via a streaming protocol 130; (5) decoding the video file; (6) playing the decoded video file for viewers 108 to consume on the user's channel; (7) gathering metadata about viewer interactions 110 including, but not limited to: (7a) the type of interaction; (7b) the time of the interaction; (7c) a viewer's 108 account details; (8) storing viewer interactions 110 for retrieval by the streaming service API(s) 112; (9) providing Streaming Service APIs; and (10) Providing Alternative API Data sources.

Functions of the one or more streaming service APIs 112 include but are not limited to: (1) retrieving viewer interactions 110 for processing; (2) processing viewer interactions 110 into stream events 136 formatted for use in the streaming service APIs 112; and (3) sending the stream events 136 to the API data collector 134 via the streaming service APIs 112.

Functions of the alternative API data sources 114 include but are not limited to: (1) receive data directly from the video game; (2) receive data from a computer vision and/or an artificial intelligence engine analysis of the game; and (3) receive data from third-party APIs related to the user's game, the user, or the viewers 108.

### Integrated Video Editing Example

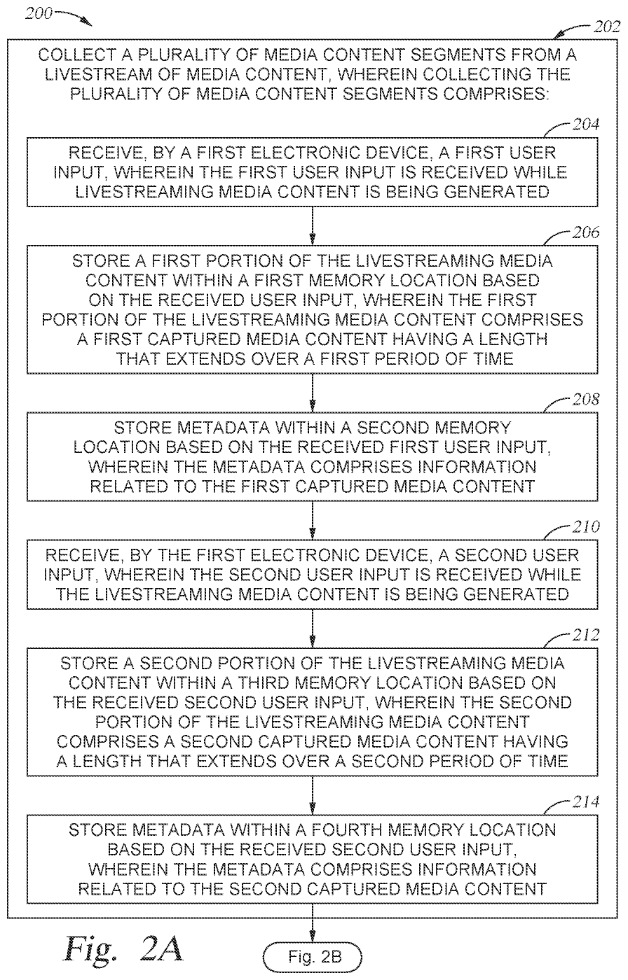

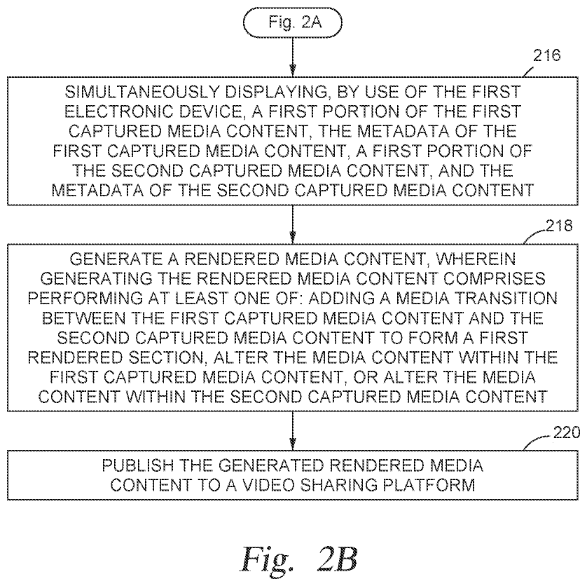

FIGS. 2A-2B illustrate a method 200 of generating media content from livestreaming media content using one or more of the elements found in the data streaming environment 100 described in FIGS. 1A-1B, according to one embodiment.

At activity 202, the method 200 includes collecting a plurality of media content segments from a livestream of media content. The live streamed media content can be provided from a source providing live video, such as a user's gaming experience. Activity 202 can include performing activities 204-214, as shown in FIG. 2A and discussed below.

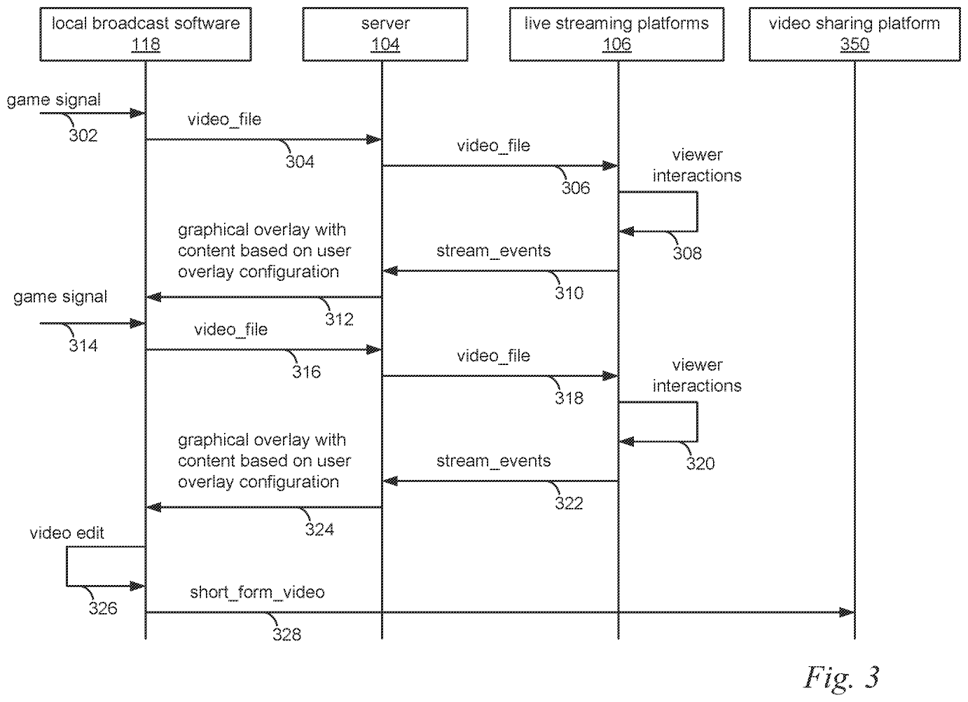

At activity 204 of activity 202, the method 200 includes receiving, by a first electronic device, a first user input. The first user input, which forms a game signal (FIG. 3), can be created by a user pressing a “hotkey” on the first electronic device, is received while livestreaming media content is being generated.

At activity 206 of activity 202, the method 200 includes storing a first portion of the livestreaming media content within a first memory location based on the received user input. In some embodiments, the first portion of the livestreaming media content comprises a first captured media content generated prior to receiving the first user input. In other embodiments, the first portion of the livestreaming media content comprises a first captured media content generated after receiving the first user input. In yet another embodiment, the first portion of the livestreaming media content comprises a first captured media content that includes a first portion generated before receiving the first user input and a second portion generated after receiving the first user input. The first captured media content includes a portion of the livestreaming media content that has a length that extends for a first period of time. In one example, after receiving the first user input the local broadcast software 118 is configured to automatically collect livestreaming media content that occurred a first period of time (e.g., 30 seconds) before the user input was received and collect livestreaming media content that occurs a second period of time (e.g., 60 seconds) after the user input was received, and thus form a livestreaming media content clip that has a fixed length (e.g., 90 seconds).

At activity 208 of activity 202, the method 200 includes storing metadata within a second memory location based on the received first user input. The metadata comprises information related to the first captured media content, such as information selected from a group consisting of an identifier associated with a user, a time stamp taken when the user's first user input was received, the livestream media content information (e.g., type of livestreaming media content), streaming platform information (e.g., information regarding), sidebar information (e.g., chat text), and information relating to real-time alerts generated during the collection of the livestream of media content.

At activity 210 of activity 202, the method 200 includes receiving, by the first electronic device, a second user input. The second user input, which forms a game signal (FIG. 3), can be formed by a user pressing a “hotkey” on the first electronic device a second time, is received while the livestreaming media content is still being generated. In some embodiments, if the second user input is received in close proximity in time from the first user input the local broadcast software 118 can use this added input to set a priority level of the livestreaming media content that is being collected. In one example, if the second user input is received in quick succession (e.g., <1 second) from the first user input the livestreaming media content that is being collected might be given a higher priority than a case where the second user input is received after a certain period of time has elapsed (e.g., 2-5 seconds) or even received while the livestreaming media content is still being collected after the first user input was received.

At activity 212 of activity 202, if the second user input is received after the first livestreaming media content has been collected and/or stored in a memory location, the method 200 includes storing a second portion of the livestreaming media content within a third memory location based on the received second user input. In some embodiments, the second portion of the livestreaming media content comprises a second captured media content generated prior to receiving the second user input. In other embodiments, the second portion of the livestreaming media content comprises a second captured media content generated after receiving the second user input. In yet another embodiment, the second portion of the livestreaming media content comprises a second captured media content that includes a first portion generated before receiving the first user input and a second portion generated after receiving the first user input. The second captured media content includes a portion of the livestreaming media content that has a length that extends for a second period of time. In one example, after receiving the second user input the local broadcast software 118 is configured to automatically collect livestreaming media content that occurred a first period of time (e.g., 30 seconds) before the user input was received and collect livestreaming media content that occurs a second period of time (e.g., 60 seconds) after the user input was received, and thus form a livestreaming media content clip that has a fixed length (e.g., 90 seconds).

At activity 214 of activity 202, the method 200 includes storing metadata within a fourth memory location based on the received second user input. The metadata can include information related to the second captured media content, such as information selected from a group consisting of an identifier associated with a user, a time stamp taken when the user's first user input was received, the livestream of media content information, streaming platform information, sidebar information, and information relating to real-time alerts generated during the collection of the livestream of media content.

Referring back to FIG. 2B, at activity 216, in one example, the method 200 includes simultaneously displaying, by use of the first electronic device, a first portion of the first captured media content, the metadata of the first captured media content, a first portion of the second captured media content, and the metadata of the second captured media content. In some embodiments, the process of simultaneously displaying the first portion of the first captured media content, the metadata of the first captured media content, the first portion of the second captured media content, and the metadata of the second captured media content is completed automatically by one or more software applications. In some embodiments, the one or more software applications include instructions that are being executed by a processor running on the first electronic device.

At activity 218, in one example, the method 200 includes generating a rendered media content that includes at least a portion of the first captured media content and the second captured media content. The process of generating the rendered media content can include performing at least one of: adding a media transition between the first captured media content and the second captured media content to form a first rendered section; altering the media content within the first captured media content; or altering the media content within the second captured media content.

At activity 220, the method 200 includes publishing the generated rendered media content to a video sharing platform. In some embodiments, the video-sharing platform can include YouTube®, Vimeo®, Facebook®, or Dailymotion®.

FIG. 3 depicts a flow of operations for the local broadcast software, the server, and the live streaming platforms, according to one embodiment. In step 302, the user creates a game signal by pressing a “hotkey” (e.g., spacebar, return, or F13 on a keyboard). In step 304, a video file is sent by the local broadcast software 118 to the server 104. The server 104 sends in step 306 the video file to one or more live streaming platforms 106. In step 308, the viewers on the live streaming platforms provide their interactions to the video file. In step 310, the viewer interactions are converted into streaming events and sent to the server 104. In step 312, a graphical overlay provided by the user has its content updated by the streaming events. In step 314, the user creates another game signal by pressing a hotkey. In step 316, another video file is sent by the local broadcast software 118 to the server. In step 318, the server sends the video file to the one or more live streaming platforms. In step 320, viewer interactions to the video file are captured by the live streaming platforms and converted to streaming events. In step 322, the streaming events provide content to the graphical overlay, and in step 326, the user performs video editing functions to create a short form video which is then sent to a video sharing platform 350.

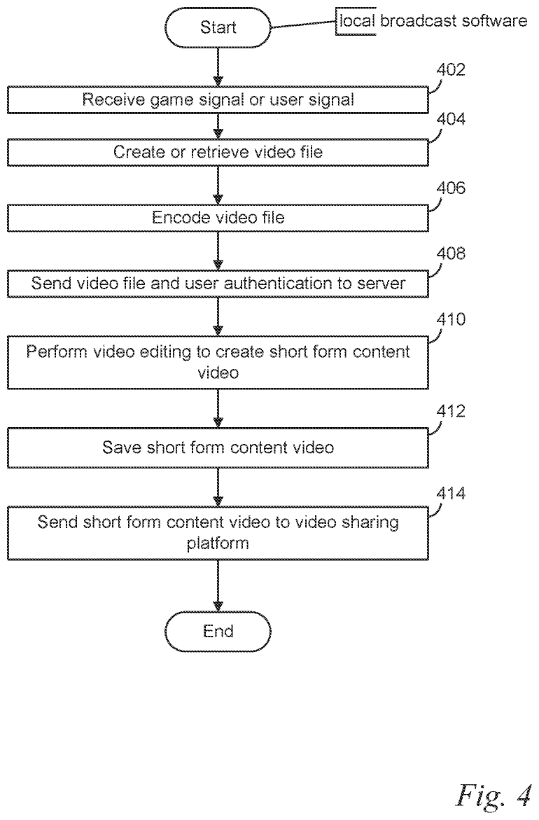

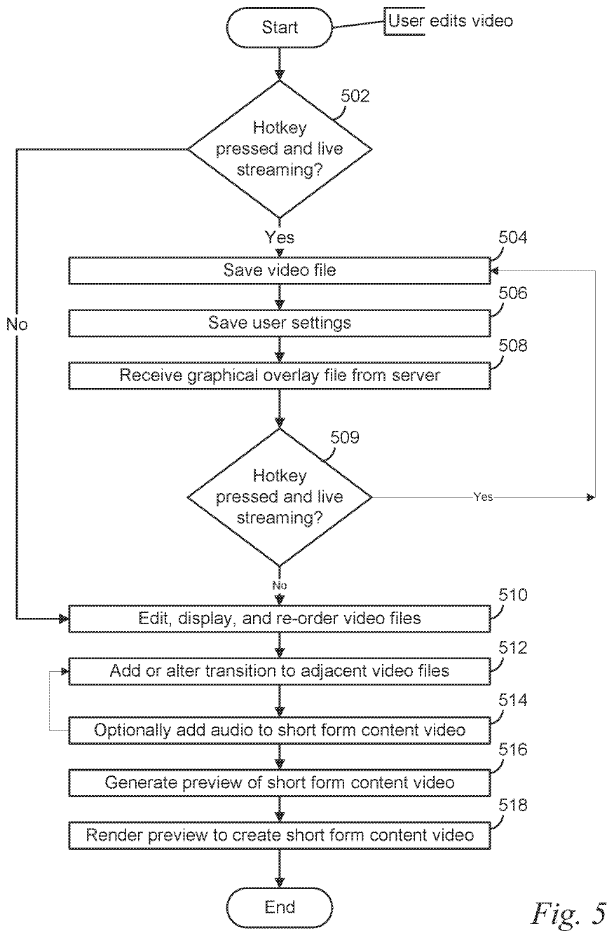

FIG. 4 depicts a flow of operations for the function of the local broadcast software, according to one embodiment. In step 402, the function receives a game or user input, such as a hotkey being pressed. In step 404, the function creates or retrieves a video file saved on a disk in the user's device. In an embodiment, the retrieved video file is tagged with an identity and represented by an icon on the screen of the user device. The function, in step 406, encodes a prescribed length of the video and sends in step 408 the encoded video file and authentication of a user to the server, where the authentication identifies the user who is the source of the video file. (See items 5-6 in the Local Broadcast Software section above). In step 410, the function performs video editing (further described in FIG. 5) to create a short-form content video. In step 412, the function saves the short form content video on the user device. (See items 6-8 in the Integrated Video Editing section above). The hotkey may be pressed multiple times, each time causing steps 404-412 to be performed.

In step 414 of FIG. 4, the function sends the short form content video to a video sharing platform. (See item 7 in the Integrated Video Editing section above). In one embodiment, the video sharing platform is the same as the live streaming platform. In some embodiments, the video sharing platform is selected based on the live streaming platform to which the video file was sent.

FIG. 5 depicts a flow of operations for the function of the user generating and editing a video, according to one embodiment. In step 502, the function determines whether the hotkey has been pressed and whether a live streaming is in process. If so, then in step 504, the function saves the video file, which has a prescribed length, to the disk in the user device, and in step 506 saves the user settings. The prescribed length may be a portion of the video before the hotkey is pressed, a portion during the live streaming, and a portion after the live streaming terminates. (See item 2 in the Integrated Video Editing section above). In step 508, the function receives a populated graphical overlay file from the server. The graphical overlay file contains stream events from the live streaming platforms and data from the alternative API data source and related metadata. In one embodiment, the stream events are tagged as to their type and time. For example, if a viewer donates funds during the live streaming, the type is a donation, and the time indicates a point in the video file to which the viewer is reacting, where a link is provided in the video or in information about the video as to where to donate the funds. In step 509, the function performs steps 502-508 each time the hotkey is pressed, resulting in multiple video files stored in the user device. However, if the end of the live streaming event is reached then the flow may then proceed on to steps 510-518.

In step 510 of FIG. 5, the function, with the help of the user, edits, displays, and re-orders the video files saved during the live streaming as well as the complete video files stored on disk that were the source of the video files sent for viewer interaction. (See item 4 in the Integrated Video Editing section above). In step 512, the function adds or alters a transition between adjacent video files. In one embodiment, a transition is selected based on the tags that identify the video file and tags identifying the streaming event which the video file received. (See item 4d of in the Integrated Video Editing section above). In step 514, the function optionally adds audio to the short form content video. (See item 4f in the Integrated Video Editing section above). In step 516, the function generates a preview for the user of the short form content video. (See item 5 in the Integrated Video Editing section above). In step 518, the function renders the preview of the short form content video. (See item 6 in the Integrated Video Editing section above).

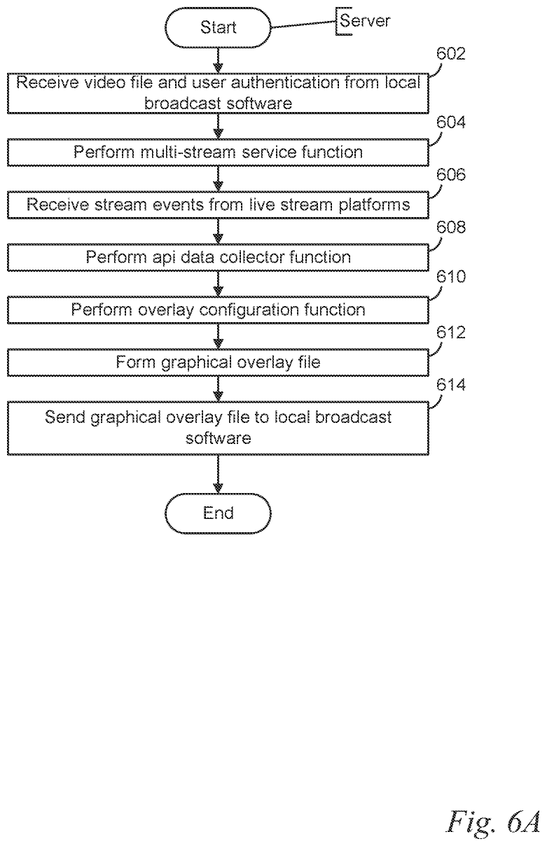

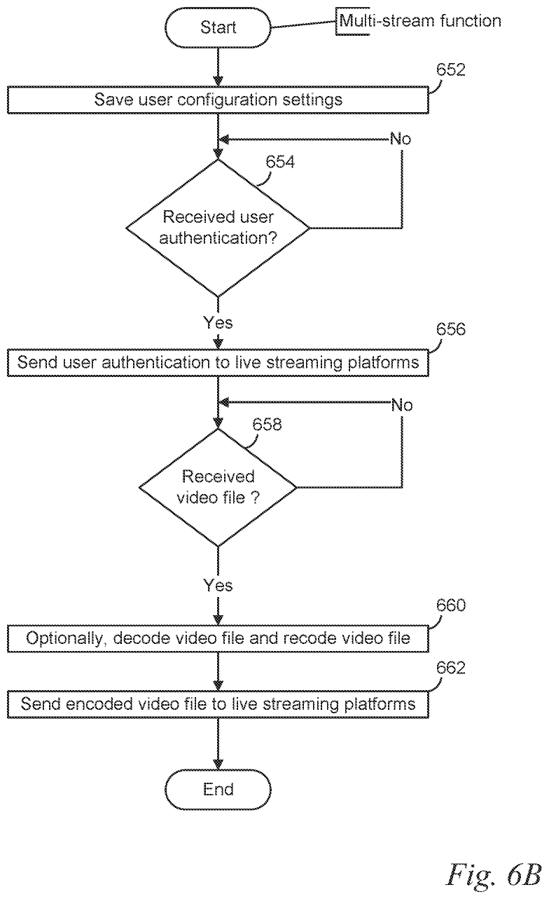

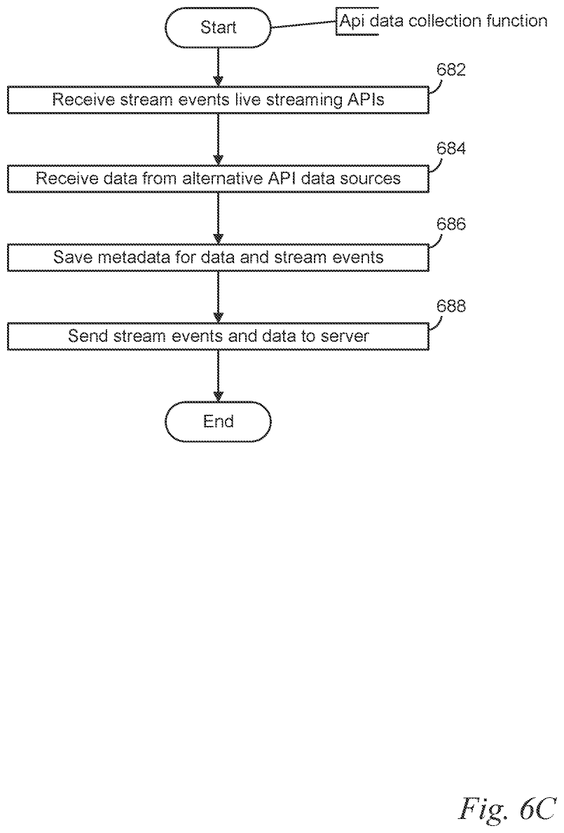

FIG. 6A depicts a flow of operations for the function of the server, according to one embodiment. In step 602, the function receives a video file and user authentication from the local broadcast software 118. (See item 4 in the Multi-Stream Service section above). In step 604, the function performs the multi-stream service, which is further described in reference to FIG. 6B. (See also item 6 in the Server Elements section above). In step 606, the function receives stream events from the live stream platforms. (See item 3c in the Multi-Stream Service section above). In step 608, the function performs the API data collector operation, which is further described in FIG. 6C. (See also items 3b and 3c in the Multi-Stream Service section above). In step 610, the function performs the overlay configuration operation, which populates the graphical overlay according to the overlay configuration specified by the user. (See in the Multi-Stream Service section above). In step 612, the function forms the graphical overlay file from the populated graphical overlay. In step 614, the function sends the graphical overlay file to the local broadcast software 118. (See item 2 in the Integrated Video Editing section above).

FIG. 6B depicts a flow of operations for the function of the multi-stream service of the server, according to one embodiment. In step 652, the function saves the user configuration settings. (See item 1 in the Multi-Stream Service section above). In step 654, the function awaits receipt of the user authentication. (See item 2 in the Multi-Stream Service section above). If the user authentication is received, as determined in step 654, then the function sends in step 656 the user authentication to the live streaming platforms. (See item 6 in the Multi-Stream Service section above). In step 658, the function awaits the receipt of the video file. (See item 4 in the Multi-Stream Service section above). If the video file is received, as determined in step 658, the function optionally decodes the video file and re-codes the video file in step 660. (See item 5 in the Multi-Stream Service section above). In step 662, the function sends the encoded video file to the live streaming platforms. (See item 6 in the Multi-Stream Service section above).

FIG. 6C depicts a flow of operations for the function of the API data collector of the server, according to one embodiment. In step 682, the function receives stream events from the live streaming APIs. In step 684, the function receives data from alternative API data sources. In step 686, the function saves the metadata for the data and stream events. In step 688, the function sends the stream events, data, and metadata to the server. (See item 3 in the Server Elements section above).

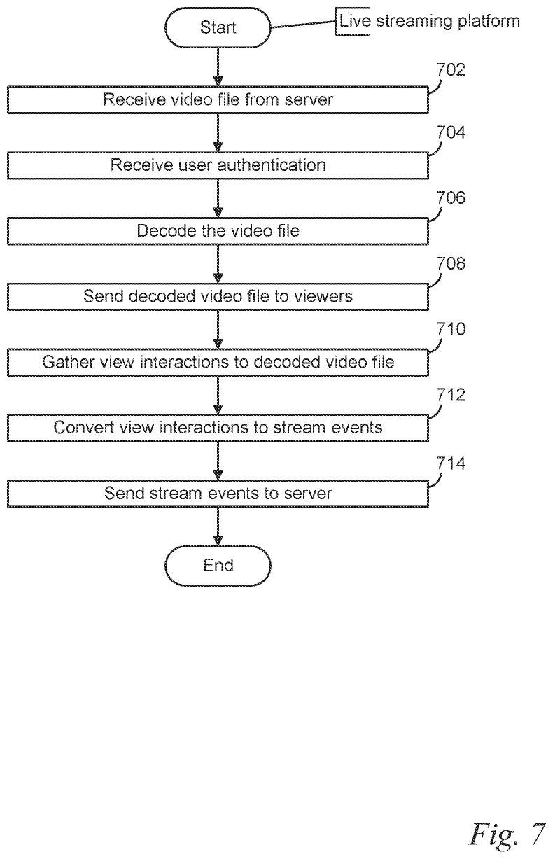

FIG. 7 depicts a flow of operations for the function of a live streaming platform, according to one embodiment. In step 702, the function receives a video file from the server. In step 704, the function receives a user authentication. (See item 2 in the Livestreaming Functions section above). In step 706, the function decodes the video file. (See item 5 in the Livestreaming Functions section above). In step 708, the function sends the decoded video file to the viewers. (See item 6 in the Livestreaming Functions section above). In step 710, the function gathers interactions from the viewers of the decoded video file. (See item 7 in the Livestreaming Functions section above). In step 712, the function converts the viewer interactions to stream events. In step 714, the function sends the stream events to the server. (See Livestreaming Functions section above).

While the foregoing is directed to embodiments of the present disclosure, other and further embodiments of the disclosure may be devised without departing from the basic scope thereof, and the scope thereof is determined by the claims that follow.

What is claimed is:

1. A method of rendering video files, the method comprising:
uploading one or more video files to a plurality of live streaming platforms;
receiving streaming event information that includes viewer interactions to the one or more video files;
editing, combining the one or more video files, and integrating the streaming event information to create a preview of a short-form content video;
rendering the preview into the short-form content video; and
sending the short-form content video to a plurality of video-sharing sites.

2. The method of claim 1, further comprising, while receiving the streaming event information, saving the uploaded one or more video files and the streaming event information in response to the receipt of a game signal.

3. The method of claim 2, wherein the game signal is generated based on input received from a user, wherein the input received from the user comprises the user pressing a hotkey.

4. The method of claim 1, further comprising sending authorization for a user to the live streaming platforms to identify the user sending the video files.

5. The method of claim 1, wherein a pre-set time interval limits a length of the one or more video files.

6. The method of claim 1, wherein streaming event information is formed by an analysis, performed by an artificial intelligence engine, of the one or more video files.

7. The method of claim 1, wherein the streaming event information conforms to a graphical overlay based on a pre-defined overlay configuration provided by a user sending the video files.

8. The method of claim 1, wherein the viewer interactions of the streaming event information include at least one of a type of viewer interaction, a time of the interaction, and viewer account details.

9. The method of claim 1,
further comprising storing the one or more video files in a buffer for use in rendering the short-form content video; and
wherein combining video files includes combining the uploaded one or more video files.

10. The method of claim 1, wherein combining video files includes providing a transition between one or more video files that are adjacent to each other in time.

11. A system for rendering video files, the system comprising:
a processor; and
a memory coupled to the processor and having loaded therein, for execution by the processor, video editing software,
wherein the video editing software is configured to:
upload one or more video files to a plurality of live streaming platforms;
receive streaming event information that includes viewer interactions to the video files;
render a short-form content video by editing, combining the video files, and integrating the streaming event information into the short-form content video; and
send the short-form content video to a plurality of video-sharing sites.

12. The system of claim 11, wherein the video editing software is further configured to, while receiving the streaming event information, save the uploaded one or more video files and the streaming event information in response to the receipt of a game signal.

13. The system of claim 11, wherein the video editing software is further configured to send authorization for a user to the live streaming platforms to identify the user sending the video files.

14. The system of claim 11, wherein streaming event information is formed by an analysis, performed by an artificial intelligence engine, of the one or more video files.

15. The system of claim 11, wherein the streaming event information conforms to a graphical overlay based on a pre-defined overlay configuration provided by a user sending the video files.

16. The system of claim 11, wherein the viewer interactions include a type of interaction, a time of the interaction, and viewer account details.

17. A non-transitory computer-readable medium comprising instructions that are executable in a processor of a computer system to carry out a method of scheduling a plurality of workloads for execution in a cluster of nodes, the method comprising:
uploading one or more video files to a plurality of live streaming platforms;
receiving streaming event information that includes viewer interactions to the one or more video files;
editing, combining the one or more video files, and integrating the streaming event information to create a preview of a short-form content video;
rendering the preview into the short-form content video; and
sending the short-form content video to a plurality of video-sharing sites.

18. The non-transitory computer-readable medium of claim 17, further comprising, while receiving the streaming event information, saving the uploaded one or more video files and the streaming event information in response to the receipt of a game signal.

19. The non-transitory computer-readable medium of claim 18, wherein the game signal is generated based on input received from a user, wherein the input received from the user comprises the user pressing a hotkey.

20. The non-transitory computer-readable medium of claim 17, wherein the method further comprises sending authorization for a user to the live streaming platforms to identify the user sending the video files.

21. The non-transitory computer-readable medium of claim 17, wherein streaming event information is formed by an analysis, performed by an artificial intelligence engine, of the one or more video files.

22. The non-transitory computer-readable medium of claim 17, wherein the viewer interactions of the streaming event information include at least one of a type of viewer interaction, a time of the interaction, and viewer account details.
